(19) United States
(12) Patent Application Publication
(10) Pub. No.: US 2016/0055512 A1
(43) Pub. Date: Feb. 25, 2016

(54) TRANSACTION FEE SURFACING SYSTEM

(71) Applicant: EBAY INC., San Jose, CA (US)

(72) Inventors: Sandy L. Godsey, San Jose, CA (US); Corinne E. Sherman, San Jose, CA (US)

(21) Appl. No.: 14/468,023

(22) Filed: Aug. 25, 2014

(51) Int. Cl. G06Q 30/02; G06Q 20/22

(52) U.S. Cl. CPC G06Q 30/0222; G06Q 20/227

(57) ABSTRACT

Systems and methods for providing a transaction fee surfacing system include a system provider device that retrieves, through communication over a network with a merchant device that is located at a merchant physical location, a product identifier for a product and determines a customer device associated with the product. The system provider also retrieves incentives associated with the product from a database located in a non-transitory memory. Additionally, the system provider device determines at least one customer payment account associated with the customer device and retrieves information associated with at least one customer payment account from the database. The system provider thus provides incentives for a particular purchase instruction associated with purchasing the product using the at least one customer payment account. The system provider then provides the incentives for display on a customer device and receives a purchase instruction selection.

### BACKGROUND

1. Field of the Invention

The present disclosure generally relates to online and/or mobile payments, and more particularly to a transaction fee surfacing system that may be used to provide transaction fee information to a customer for one or more customer payment methods that are available to make an online and/or mobile payment.

2. Related Art

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

Some payment service providers provide online and mobile payment services for merchants with merchant physical locations and their customers in order to allow the customers to make purchases from the merchants at the merchant physical locations. When shopping at a particular merchant physical location (e.g., a department store, a grocery store, etc.), customers may choose from a variety of payment methods at their disposal (e.g., cash, a particular credit card, or a particular debit card) to pay for goods and/or services at the merchant physical location. Oftentimes, such a choice depends at least in part on rewards and/or discounts offered by a merchant (e.g., for repeat customers or for purchasing particular products), rewards and/or discounts offered by a bank (e.g., reward points for paying with a particular bank-issued card), etc. However, such incentives offered by a merchant or a bank are often unknown to a customer at the time of purchase. Moreover, to the extent that incentive offers are known, customers may not be aware of better, competing incentive offers.

Thus, there is a need for a transaction fee surfacing system that provides merchants, customers, account providers, payment providers, product manufacturers, and others that may be involved in a purchase transaction with a reliable and transparent way to share transaction fee information, incentives, and/or other offers, particularly with customers that may choose between two or more methods of payment.

### BRIEF DESCRIPTION OF THE FIGURES

FIG. 1 is a schematic view illustrating an embodiment of a transaction fee surfacing system;

FIG. 2 is a schematic view illustrating an embodiment of a beacon device;

FIG. 3A is a schematic view illustrating an embodiment of the transaction fee surfacing system of FIG. 1 that includes a plurality of the beacon devices of FIG. 2;

FIG. 3B is a schematic view illustrating an embodiment of the transaction fee surfacing system of FIG. 3A with the beacon devices providing communication areas;

FIG. 4 is a schematic view illustrating an embodiment of a system provider device connected to beacon devices in the transaction fee surfacing system of FIG. 3 and to customer database and merchant physical location databases to provide a transaction fee surfacing system;

FIG. 5 is a flow chart illustrating an embodiment of a method for providing transaction fee information to a customer;

FIG. 6 is a screen shot illustrating an embodiment of a customer device displaying a customer check-in screen at a merchant location;

FIG. 7 is a schematic view illustrating an embodiment of a transaction fee surfacing system including a customer conducting a transaction at a merchant point of sale;

FIG. 8 is a screen shot illustrating an embodiment of a customer device displaying a payment screen;

FIG. 9 is a screen shot illustrating an embodiment of a customer device displaying a payment confirmation screen;

FIG. 10 is a screen shot illustrating an embodiment of a customer device displaying a payment receipt screen;

FIG. 11 is a schematic view illustrating an embodiment of a networked system;

FIG. 12 is a perspective view illustrating an embodiment of a customer device;

FIG. 13 is a schematic view illustrating an embodiment of a computer system; and

FIG. 14 is a schematic view illustrating an embodiment of a system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for providing a transaction fee surfacing system that provides merchants, customers, account providers, payment providers, product manufacturers, and/or others with a reliable and transparent way to share transaction fee information, incentives, and/or other offers, particularly with customers choosing between two or more methods of payment. As used herein, the term “transaction fee” generally refers to interchange fees, swipe fees, and/or a variety of other fees known in the art which may include a fee paid by a merchant to a card-issuing bank (e.g., credit or debit card issuing bank) as well as to a credit card company for processing a credit and/or a debit card transaction. Further, as used herein, the term “transaction fee surfacing” is used to describe making the interchange, swipe, or other fees apparent, and in particular as described in various embodiments, making such fees apparent to a customer at a time a time-of-purchase. A “time-of-purchase”, as described herein, may include a time at which a purchase transaction occurs at a physical point of sale (e.g., at a physical merchant location) or at a virtual point of sale, and including for example, a virtual storefront accessible to a customer via a website (e.g., accessible through an Internet connection using a mobile device and/or a personal computer). In other examples, such a virtual storefront may be accessible to a customer by way of a mobile application executing on the customer's mobile device.

In some examples described herein, incentives and/or offers may be provided by a merchant, a manufacturer, a payment service provider, an account provider, and/or other transaction intermediaries. In some embodiments, such incentives and/or offers may include one or more discounts offered to a customer in return for paying with a certain method of payment (e.g., cash, credit, or debit). Alternatively, or in addition, other offers and/or incentives may be made available such as, for example, receiving credit card points for paying with a particular credit card. In some examples, a merchant may also be incentivized to encourage a customer to pay with a certain type of payment. For example, a merchant may pay lower transaction fees when the customer pays with a specific type of card. Additionally, in some examples, a manufacturer may offer incentives to a merchant and/or customer for purchasing particular products and/or paying with a certain method of payment. While a few examples of incentives and/or offers have been described, one of skill in the art will recognize other incentives and/or offers which may be implemented, while remaining within the scope of the present disclosure.

Conventionally, customers going through a checkout process (i.e., itemization and collection of an amount due for purchases) at a physical or virtual point of sale may have a plurality of payment methods available at their disposal. For example, a customer may be prepared to pay with cash, with one or more credit cards, with one or more debit cards, with one or more gift cards, and/or with other methods of payment. Often, a customer's choice of one particular method of payment over another may be driven by convenience, by disposable credit available on one or more credit cards, by an amount available in a checking/savings account (e.g., in the case of a debit card), and/or by which methods of payment (e.g., which credit cards) a particular merchant accepts. Moreover, a customer's choice to use a particular credit or debit card may also be influenced by an incentive and/or offer provided by a merchant, bank, payment service provider, product manufacturer, service provider, or other third-party as described above. However, a customer may not be readily aware of all such offers and/or incentives available to the customer at the time-of-purchase. Merely by way of example, consider a particular merchant that accepts two credit cards ‘A’ and ‘B’. Further, consider that a customer, having both cards ‘A’ and ‘B’, is well-aware that credit card ‘A’ offers “reward points” for every purchase made using the credit card ‘A’. As used herein, “reward points” may be exchanged (i.e., redeemed) by a customer for cash, gift cards, merchandise, travel rewards, and/or other rewards as known in the art. The customer, however, may not be aware that credit card ‘A’ has a higher transaction (i.e., interchange) fee than credit card ‘B’, and the merchant may be willing to offer the customer a lower price on a particular item (or for an entire transaction) if the customer uses credit card ‘B’ instead of credit card ‘A’. If such information were made available to the customer at the time-of-purchase, the customer would (at the least) be able to make a more informed decision that in some instances may be mutually beneficial to both the merchant and the customer (e.g., such as if the customer chose to use credit card ‘B’ in the above example). Thus, in accordance with the various embodiments described herein, customers may be readily able to view transaction fee information (e.g., via a transaction fee surfacing system described herein), incentives and/or other offers (e.g., provided by a merchant, bank, payment service provider, product manufacturer, service provider, and/or other third-party) and quickly compare such information in order to help choose between two or more methods of payment at a customer's disposal. Thus, the embodiments described herein provide a customer with the ability to select an optimum method of payment (e.g., as determined by the customer) for any of a variety of merchant/customer interactions and situations.

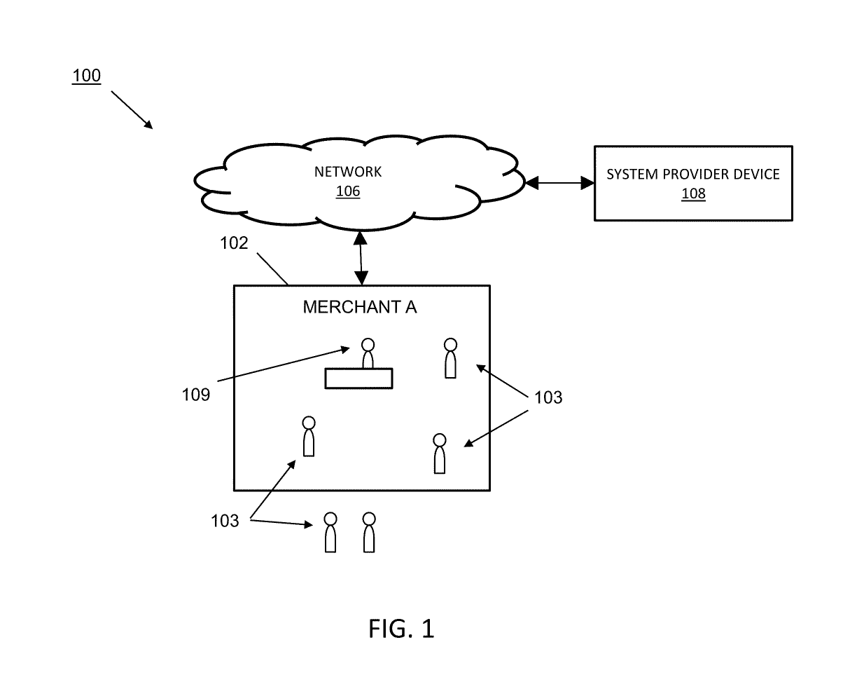

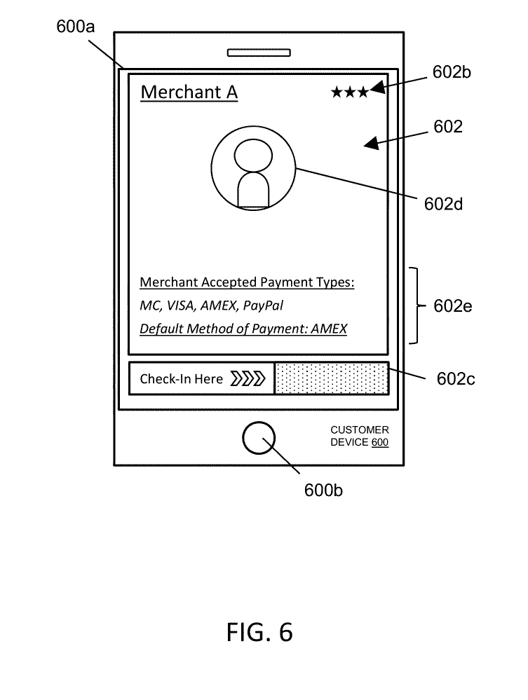

Referring now to FIG. 1, an embodiment of a transaction fee surfacing system 100 is illustrated. The transaction fee surfacing system 100 includes a merchant 102 (illustrated and equivalently referred to as “Merchant A”) having a merchant physical location. While the embodiments herein are shown and described with reference to a single merchant for the sake of clarity, it will be understood that various embodiments may include a plurality of merchants at a plurality of merchant physical locations, and/or a single merchant having a plurality of merchant physical locations. In various examples, the merchant 102 includes one or more merchant devices that are coupled to a network 106 that is further coupled to a system provider device 108. For example, the merchant 102 and the system provider device 108 are configured to communicate with one another by way of the network 106, for example by way of network communication devices, as discussed below. In the embodiments illustrated and discussed below, the merchant 102 may provide a department store. However, one of skill in the art in possession of the present disclosure will recognize that the transaction fee surfacing system 100 described herein may be utilized with virtually any merchant type located at virtually any merchant physical location such as, for example, a restaurant, a grocery store, a pharmacy, a movie theater, a theme park, a sports stadium, and/or a variety of other merchant physical locations known in the art. Moreover, in some embodiments, the merchant 102 physical location may include a mobile merchant location such as a cart, kiosk, trailer, and/or other mobile merchant location as known in the art. As one example, and with reference to the embodiments of FIGS. 6-10, the merchant 102 physical location includes a department store, as discussed in further detail below.

The network 106 may be implemented as a single network or a combination of multiple networks. For example, in various embodiments, the network 106 may include the Internet and/or one or more intranets, landline networks, wireless networks, cellular networks, satellite networks, and/or other appropriate types of networks. In some examples, the merchant 102 may communicate through the network 106 via cellular communication, by way of one or more merchant network communication devices. In other examples, the merchant 102 may communicate through the network 106 via wireless communication (e.g., via a WiFi network), by way of one or more merchant network communication devices. In yet other examples, the merchant 102 may communicate through the network 106 via any of a plurality of other radio and/or telecommunications protocols, by way of one or more merchant network communication devices. In still other embodiments, the merchant 102 may communication through the network 106 using a Short Message Service (SMS)-based text message, by way of one or more merchant network communication devices.

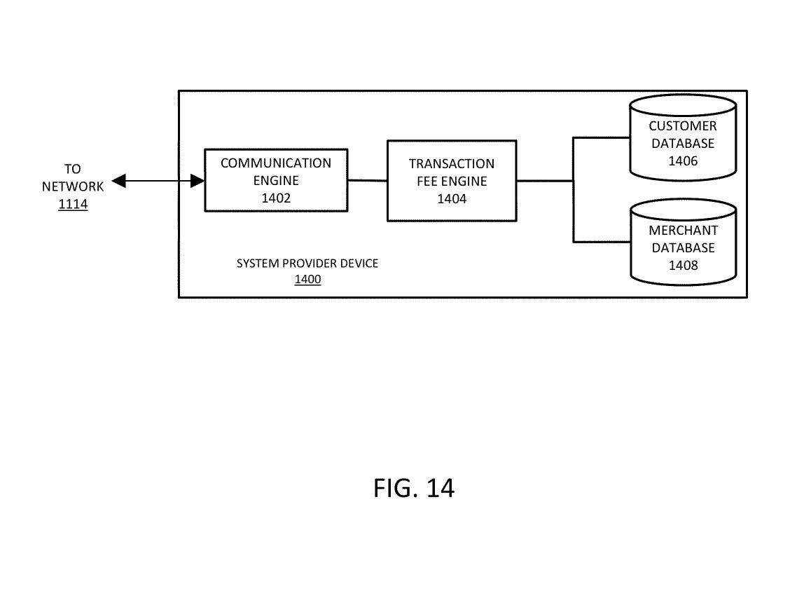

The system provider device 108 may likewise couple to the network 106 via a wired or wireless connection. As described in more detail below with reference to FIG. 14, the system provider device 108 may include a transaction fee engine, a communication engine, a merchant information database, and a customer database. Software or instructions stored on a computer-readable medium, and executed by one or more processors of the system provider device 108, allows the system provider device 108 to send and receive information over the network 106. Furthermore, the transaction fee engine in the system provider device 108 may be configured to implement the various embodiments of the transaction fee surfacing system as described herein. In some examples, the system provider device 108 is configured to provide (e.g., to a customer) transaction fee information, incentive information, and/or information regarding other offers related to a customer transaction, thus providing a customer with an ability to compare a cost-benefit of using one form of payment versus another form of payment.

In the embodiment illustrated in FIG. 1, one or more customers 103 may be shopping at, arriving at, or leaving from the Merchant A physical location. The arrival, departure, and/or position of the one or more customers 103 may be detected by way of one or more beacon devices in a beacon system, as discussed below. In some embodiments, the system provider may include a payment service provider such as, for example, PayPal Inc. of San Jose, Calif., that provides the transaction fee surfacing system 100 for the merchant 102 at the merchant location, as well as any other merchants implementing the transaction fee surfacing system 100. In some embodiments, the payment service provider provides transaction fee information, as well as incentive/offer information (e.g., provided by the merchant 102, a bank, the payment service provider, a product manufacturer, a service provider, etc.) to a customer for a plurality of payment methods at the customer's disposal. In some embodiments, as discussed below, the payment service provider processes payment requests from the merchant 102, processes payments from customers to the merchant 102, and may associate a merchant physical location (or its merchant such as merchant 102), a customer location (or its customer), merchant devices, customer devices, and/or other components of the transaction fee surfacing system 100 with a merchant account in a database located in a non-transitory memory. For example, the payment service provider may use a payment service provider device to transfer funds from a customer payment account (e.g., provided by an account provider through an account provider device, provided by the payment service provider through the payment service provider device, etc.) of the customer to a merchant payment account (e.g., provided by an account provider through an account provider device, provided by the payment service provider through the payment service provider device, etc.) of the merchant to provide payment from the customer to the merchant during a transaction.

Information sent and received through the network 106, merchant devices, and customer devices may be associated with merchant 102 accounts in the database, and any use of that information may be stored in association with such merchant 102 accounts. Furthermore, the payment service provider may provide the transaction fee surfacing system 100 for a plurality of different merchants at various merchant physical locations, similarly as described for the merchant 102, discussed below. Thus, references to a system provider operating a system provider device below may refer to a payment service provider operating a payment service provider device, or may refer to any other entity providing a transaction fee surfacing system separate from or in cooperation with a payment service provider.

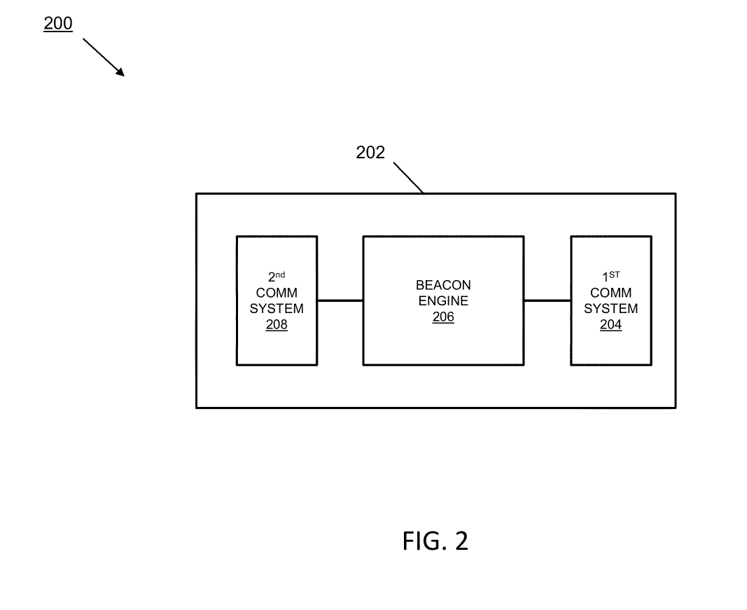

Referring now to FIG. 2, an embodiment of a beacon device 200 is illustrated. The beacon device 200 includes a chassis that houses a first communications system 204 such as, for example, a WiFi communications system, a cellular communication system, and/or a variety of other communication systems known in the art. The first communications system 204 is coupled to a beacon engine 206 that may be provided by instruction on a memory system (not illustrated) in the beacon device 200 that, when executed by a processing system (not illustrated) in the beacon device 200, causes the processing system to perform the functions of the beacon device 200 discussed below. The beacon engine 206 is coupled to a second communication system 208 such as, for example, a Bluetooth® Low Energy (BLE) communication system, a BLE direct communication system, a Near Field Communication (NFC) system, and/or a variety of other communication systems known in the art. The beacon engine 206 may be configured to receive any of a variety of sensor signals through the second communication system 208 and transmit those sensor signals using the first communication system 204. While a few examples of communications components in the beacon device 200 have been described, one of skill in the art will recognize that other communications devices, as well as other components that have been omitted for clarity of discussion and illustrated, may be included in the beacon device 200 and will fall within the scope of the present disclosure. One of skill in the art will recognize that the components described above allow for the beacon device to be provided in a relatively small form factor such that it may be placed inconspicuously almost anywhere. As such, the chassis 202 of the beacon device 200 may include any of a variety of features that allow for the coupling of the beacon device to any part of a merchant physical location, such as a merchant physical location associated with the merchant 102.

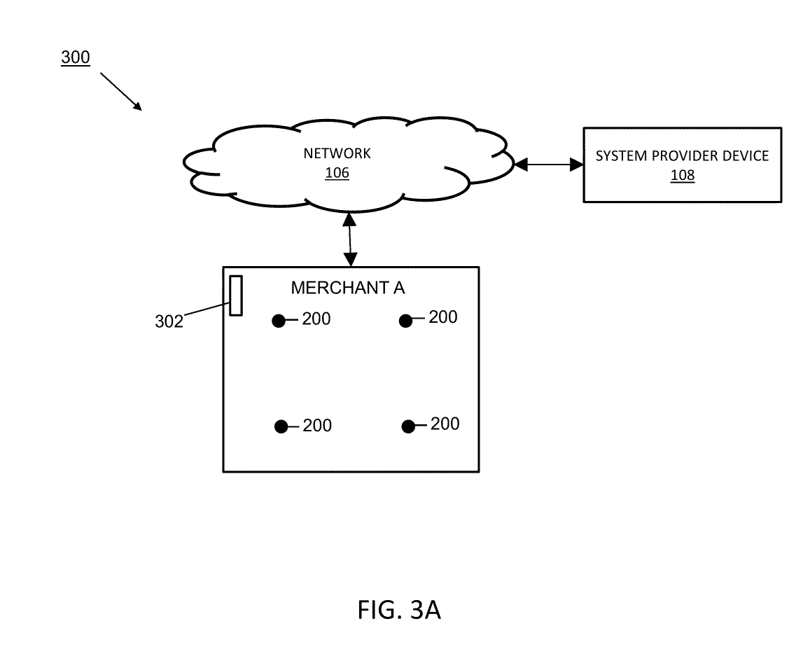

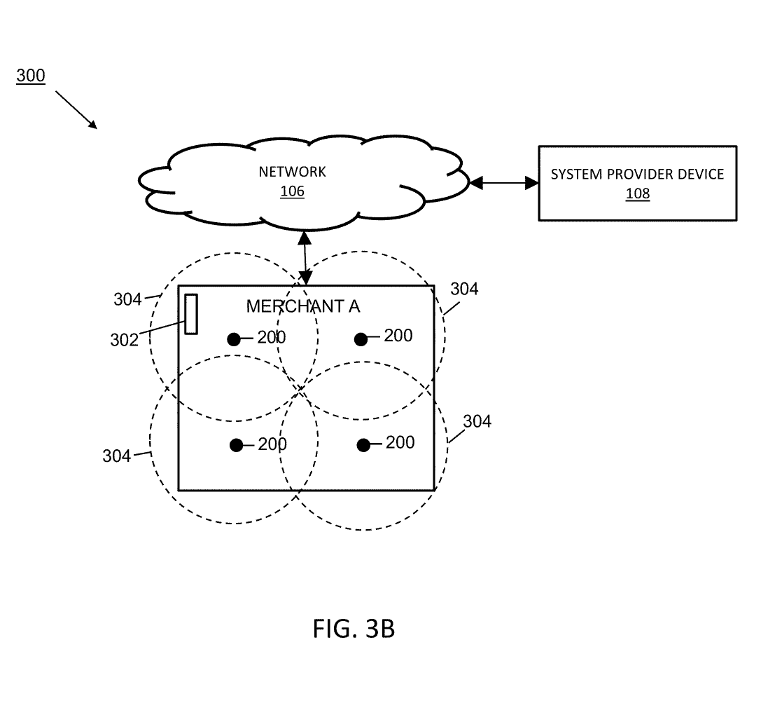

Referring now to FIGS. 3A and 3B, an embodiment of a transaction fee surfacing system 300 is illustrated. As illustrated in FIG. 3A, the transaction fee surfacing system 300 may be provided by positioning a plurality of the beacon devices 200, discussed above with reference to FIG. 2, in and around the merchant physical location associated with the merchant 102, discussed above with reference to FIG. 1. As discussed above, the beacon devices 200 may be sized such that they may be inconspicuously positioned virtually anywhere in or around the merchant physical location. For example, the beacon devices 200 may be positioned on a ceiling within various areas of an interior of the merchant physical location and/or in any other part of the merchant physical location associated with the merchant 102. Each of the beacon devices 200 in the transaction fee surfacing system 300 may be configured to wirelessly communicate, via its first communications system 204, with a merchant network communication device 302 such as, for example, a WiFi wireless router or other computing system connected to a network such as the Internet.

Referring now to FIG. 3B, in operation, each of the beacon devices 200 is configured to create a communication area 304 with its second communications system 208. For example, the second communications system 208 in each beacon device 200 may be a BLE communications device that provides an approximately 100 foot radius communications area. Depending on a desired coverage area, the power of individual beacon devices may be turned up or down to cover different sized areas, such that individual beacons within the location may have the same or different size coverage areas. However, other communications systems providing other communications areas are envisioned as falling within the scope of the present disclosure. As can be seen in the illustrated embodiment, the beacon devices 200 may be positioned in and around the merchant physical location associated with the merchant 102 such that the communications areas 304 abut, overlap, or otherwise provide coverage for any area of interest within and around the merchant physical location associated with the merchant 102. One of skill in the art in possession of the present disclosure will appreciate that different configurations of the beacon devices 200 within and around the merchant physical location associated with the merchant 102 may be selected to cover any area within and around the merchant physical location with a communications area 304.

As discussed in further detail below, each of the beacon devices 200 are configured to communicate with customer devices within their respective communications area 304 (e.g., using the second communication system 208) to collect information, and then send that information to the merchant network communication devices 302 (e.g., using the first communication system 204) such that the data may be provided to a merchant device, a system provider device, and/or any other device operating to provide the transaction fee surfacing system discussed below. In an embodiment, each of the beacon devices 200 may communicate with a database at the merchant physical location associated with the merchant 102 to retrieve real-time merchant and/or customer information, as discussed in further detail below.

In some of the figures associated with the embodiments discussed below, the beacon devices 200 and their communications areas 304 are not shown for the sake of clarity, but it should be understood that the communications and retrieval of information from beacon communication devices, and the provision of that information to a system provider device, may be accomplished using beacon devices providing communications areas such as the beacon devices 200 and communications areas 304 illustrated in FIGS. 3A and 3B. While a specific example of a transaction fee surfacing system 300 is provided, one of skill in the art in possession of the present disclosure will recognize that a wide variety of different merchant physical locations may incorporate the beacon devices 200 in a variety of different manners while remaining within its scope.

In the embodiments discussed below, the transaction fee surfacing systems and methods involve a system provider using a system provider device to detect events associated with a merchant point of sale transaction (e.g., scanning an item at a register of a merchant physical location) by communicating, through the beacon devices 200, with customer devices and/or merchant devices at the merchant physical location associated with the merchant 102. In some embodiments, events associated with a merchant point of sale transaction may also include events associated with a merchant virtual storefront, such as proceeding to a “checkout” portion of a merchant online payment interface. The system provider device may also retrieve information related to one or more payment accounts available to a customer, as well as information regarding forms of payment which the merchant 102 accepts. Item(s) selected for purchase by the customer may be linked, by the system provider device, to the customer and/or to the customer device. Additionally, availability of one or more offers and/or incentives may be determined by the system provider device, based at least in part on one or more of the item(s) selected for purchase, the payment accounts available to the customer, the forms of payment accepted by the merchant 102, as well as others described below and/or which may be known in the art. The system provider device may further analyze and compare the cost of purchasing the item(s) selected for purchase using each of the customer-available payment accounts and thus provide such information to the customer and allow the customer to select a preferred method of payment. Generally, the system provider device may provide customers with transaction fee information as well as information regarding incentives and/or other offers (e.g., provided by a merchant, bank, payment service provider, manufacturer, or other third-party) for each of the methods of payment at a customer's disposal for purchase of the selected item(s). The system provider device may also store customer and/or merchant information (e.g., customer payment account information, customer payment preferences, merchant payment preferences, merchant offers, merchant physical location, customer physical location, etc.) in a database located at the merchant physical location associated with the merchant 102 and/or the customers, or at a remote database, for example, by way of a network connection. In some embodiments, the system provider device may be a merchant device that is local to the merchant physical location associated with the merchant 102 and that communicates with the beacon devices 200 using the merchant network communication device 302. In other embodiments, the system provider may be, for example, a payment service provider as discussed above.

Furthermore, FIGS. 1, 3A, and 3B illustrate a merchant physical location associated with the merchant 102 where the physical location is a single building, with the beacon devices 200 positioned to provide communications areas 304 that cover the interior of that single building, a parking area of the single building, and/or outside sections of that single building. However, beacon devices 200 may be positioned virtually anywhere to retrieve information associated with a merchant physical location. For example, beacon devices 200 may be positioned to provide coverage to portions of a parking area, throughout an entire parking lot, at the entrances or exits of that parking lot, and/or anywhere else relative to that parking lot in order to collect and send information from customer devices to the system provider device. In another example, the merchant physical location may be located in a mall, and beacon devices may be positioned around that mall, at the entrances or exits of that mall, and/or anywhere else relative to that mall in order to collect and send information from customer devices to the system provider device. In yet other examples, the merchant physical location may include a mobile location such as a cart, kiosk, trailer, and/or other mobile location as known in the art, and beacon devices may be positioned along an interior and/or exterior portion of such a mobile location, in a customer seating area of that mobile location, in a customer parking area of that mobile location to provide coverage of the mobile location and/or surrounding areas. In some examples, the first communication system may be connected to WiFi networks available outside the merchant physical location in order to communicate collected information to a system provider device. In other examples, the first communication system may be a cellular communications system that allows the beacon devices to be positioned anywhere in range of a cellular communications tower, allowing beacon devices to be positioned in virtually any physical location when providing the transaction fee surfacing system. As such, one or more events associated with providing customers with transaction fee information as well as information regarding incentives and/or other offers for each of the methods of payment at a customer's disposal for purchase of one or more selected items may be performed, at least in part, based on customer actions that are performed outside a merchant physical location.

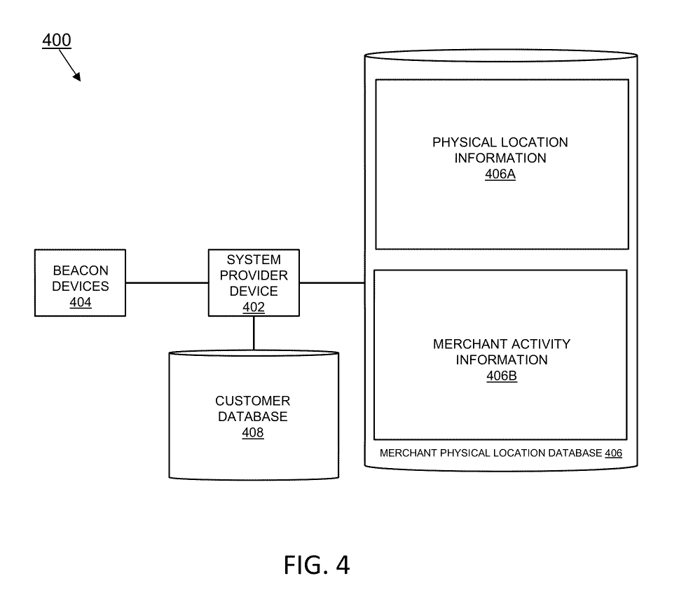

Referring to FIG. 4, an embodiment of a portion of a transaction fee surfacing system 400 is illustrated that may be used to implement one or more embodiments of the systems and methods of the present disclosure such as, for example, to detect events associated with providing customers with transaction fee information as well as information regarding incentives and/or other offers, as described below. The transaction fee surfacing system 400 includes a system provider device 402 communicatively coupled to beacon devices 404 (which may be the beacon devices 200 discussed above), a merchant physical location database 406, and a customer database 408. While illustrated as single databases, the merchant physical location database 406 and customer database 408 may include multiple databases that may be located at the merchant physical location associated with the merchant 102 and/or coupled to system provider device 402 by a network (e.g., the Internet).

In an embodiment, the merchant physical location database 406 may store merchant physical location information 406A and merchant activity information 406B. The merchant activity information may include for example, a number of customers, a number of transactions, a rate of transactions, a rate of revenue, social network check-ins, a list of potential customers (e.g., customers that have checked-in or which have been detected by the beacons 200), as well as merchant and/or manufacturer offer and promotion information, and/or other merchant activity information as known in the art. In some examples, the merchant activity information may be updated in real-time as customers move into and out of the range of the beacons 200 at the merchant physical location, as transactions (e.g., purchases) are completed, as customers check-in, and/or as one or more offers or promotions begin, expire, or are changed. Furthermore, the customer database 408 may store customer information such as customer account information, customer device information, customer purchase histories, customer preferences, and/or a variety of other customer information known in the art. In some embodiments, the merchant physical location database 406 may also store product inventory information, including product identifier information, as well as information regarding associations between a specific customer and/or customer device and a specific product.

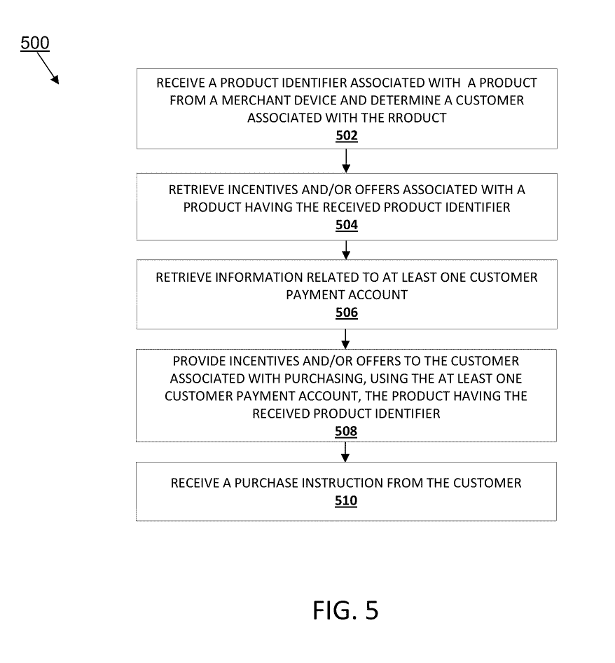

Referring now to FIG. 5, an embodiment of a method 500 for providing transaction fee information to a customer for comparison of a plurality of payment methods is illustrated. One of skill in the art in possession of the present disclosure will recognize that the method 500 may be performed for a plurality of different merchants at a variety of physical locations. The method 500 begins at block 502 where a product identifier associated with a product is received from a merchant device, and a customer is determined to be associated with the product. In particular, with reference to FIGS. 6-10, a specific example of the method 500 is illustrated and described. Referring first to FIG. 6, a customer device 600 is illustrated that includes a display 600a, for example having a touchscreen user interface, and an input button 600b. While the customer device 600 is illustrated and described as a mobile phone, a variety of other customer devices are envisioned as falling within the scope of the present disclosure. In various embodiments, a customer associated with the customer device 600 may launch a system provider application and/or a payment service provider application (e.g., a payment application provided by PayPal, Inc. of San Jose, Calif.). In some embodiments, a location of the customer device 600 may be determined by the system provider (e.g., using GPS coordinates, triangulation, or other location determination techniques). In some examples, information for a local merchant (e.g., “local” meaning near the present location of the customer device 600) is displayed in a display 602 of the customer device 600. In the example of FIG. 6, information for a merchant “Merchant A” is displayed in the display 602. In addition to displaying a merchant name, the display 602 may also include a merchant rating 602b, and a check-in slider 602c that allows customers in proximity to a merchant location to “check-in” to the merchant location, as discussed below. In some examples, a customer photo or icon 602d may also be displayed, for example, to assist a merchant with identification of a customer to ensure accurate completion of a customer transaction. In addition, in some examples, a payment information portion 602e may be displayed. As shown in FIG. 6, the payment information portion 602e may include information regarding merchant accepted payment types (e.g., types of credit and/or debit cards that the merchant accepts), as well as a customer default and/or preferred method of payment (e.g., a default and/or preferred credit or debit card).

In some embodiments, when a customer is in proximity to the merchant 102 location (e.g., determined via the customer device 600 associated with the customer), then the customer may be allowed to “check-in” to the merchant 102 location. In some examples, the customer may check-in to the merchant 102 location by sliding the check-in slider 602c from left to right across the touchscreen user interface of the customer device 600. In embodiments of the present disclosure, a customer may “check-in” in order to pay for goods and/or services by, for example, utilizing a payment service provider (e.g., PayPal, Inc.). In some embodiments, the customer may be automatically checked-in to the merchant 102 location, for example, when the customer is in proximity to the merchant 102 location. In some examples, when a customer checks-in to the merchant 102 location, the system provider device 108 may notify the merchant 102. In some embodiments, such a check-in notification received by a merchant 102 device from the system provider device 108 may include the customer photo or icon 602d. In some embodiments, after a customer has checked-in, the merchant may issue a bill to the customer for goods provided and/or services rendered. Thereafter, as described below, the customer may choose a particular method of payment based on the transaction fee information as well as information regarding incentives and/or other offers provided by the merchant 102.

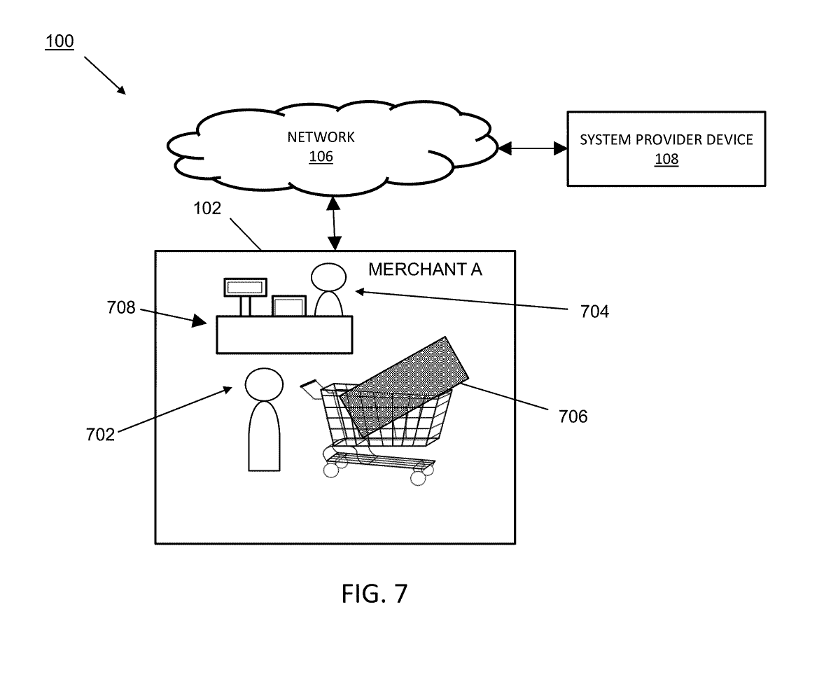

Continuing with the above example, and with reference to FIG. 7, a customer 702 shopping at the Merchant A location is illustrated. In particular, the customer 702 has selected one or more items for purchase 706 and has approached a point of sale 708 (e.g., a cash register) of the Merchant A. In various examples, the point of sale 708 may include an electronic or manual cash register, a barcode scanner or barcode reader, a scale, and/or other point of sale features known in the art. By way of example, the one or more items 706 may each include a barcode, defined herein as a machine-readable (e.g., by way of the barcode scanner or reader) representation of data which is attached to the one or more items 706 and serves to identify each of the one or more items 706. Thus, such barcode information may be equivalently referred to herein as a product identifier. In various examples, the product identifier information may be linked to a breadth of information related to each of the one or more items 706, such as an item price, inventory information, location information, as well as offers and/or incentives associated with the item such as manufacturer and/or merchant incentives. In some examples, a Merchant A employee 704 scans the barcode(s) of the one or more items 706 (e.g., using a barcode scanner), and the product identifier information is communicated, via the network 106, to the system provider device 108. In some embodiments, the point of sale 708 includes a customer self-service register, and the customer 702 may thus scan the barcode(s) of the one or more items 706 themselves and resulting in communication of the product identifier information, via the network 106, to the system provider device 108.

In various examples, the product identifier described above is associated with a product that is associated a customer (e.g., with the customer device 600). For example, in some embodiments, the employee 704 may manually enter customer and/or customer device 600 identifying information (e.g., a phone number, account number, etc.) either prior to or subsequent to scanning the barcode(s) of the one or more items 706. Alternatively, in some examples, the system provider application and/or the payment service provider application executing on the customer device 600 may provide a barcode in the display 602, which provides customer and/or customer device 600 identifying information, and which may be scanned by the point of sale 708 barcode reader. In embodiments that include the customer self-service register, the customer 702 may manually enter the identifying information (e.g., a phone number, account number, etc.) and/or the customer 702 may manually scan the barcode provided in the display 602. In yet other examples, customer and/or customer device 600 identifying information may be automatically communicated (e.g., via the beacon devices 200), via the network 106, and to the system provider device 108. Regardless of the method by which the customer and/or customer device 600 identifying information is communicated to the system provider device 108, the system provider device 108 is configured to associate the one or more items 706 with the customer and/or the customer device 600. While some examples of associating a product and/or product identifier with a customer and/or a customer device 600 have been provided, those skilled in the art in possession of the present disclosure will recognize other methods of determining such an association while remaining within the scope of the present disclosure.

Thus, following block 502, the system provider device has received product identifiers for each product selected by the customer for purchase from the merchant (e.g., via the product identifiers on those products), and has determined the identity of the customer selecting those products (e.g., via receiving a customer identifier along with the product identifiers, by determining a proximity of the customer to the merchant check-out device receiving the product identifiers, etc.) As discussed below, these actions allow the system provider device to retrieve information about the customer, merchant, products, payment methods, etc. that allow the incentives/offers discussed below to be provided to the customer.

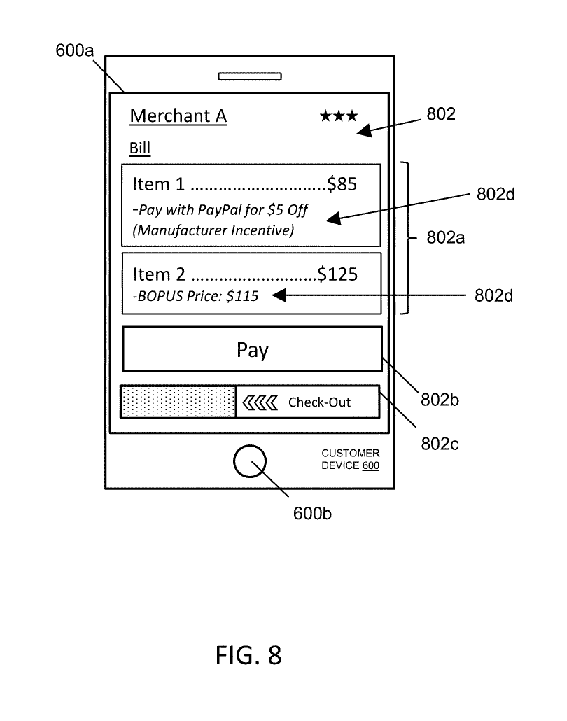

The method 500 proceeds to block 504 where incentives and/or offers associated with a product, which is identified by the received product identifier, are retrieved. By way of example, and with reference to FIG. 8, a specific example of block 504 is illustrated. Offers and/or incentives associated with the product may include offers and/or incentives provided by a merchant, bank, payment service provider, product manufacturer, service provider, or other third-party as described above. The customer (e.g., the customer 702), who has previously checked-in to the Merchant A location, may receive an electronic bill (e.g., from the payment service provider) for the one or more items 706. For example, as shown in FIG. 8, the customer device 600 displays a payment screen 802 associated with the Merchant A. As shown, the payment screen 802 provides the customer associated with the customer device 600 with an itemized bill of the goods and/or services selected for purchase from the Merchant A. For example, the payment screen 802 may include an itemized bill section 802a, a pay button 802b, and a check-out slider 802c that allows customers to check-out from the merchant location. By way of example, the itemized bill section 802a may further include an offers/incentives section 802d, which displays the retrieved incentives and/or offers associated with each of the products included in the itemized bill section 802a. In the example of FIG. 8, the offers/incentives section 802d of ‘Item 1’ includes a manufacturer incentive of $5 off the retail purchase price for Item 1 ($85), if the customer pays using the customer's payment service (“PayPal”) account. Further, the offers/incentives section 802d of ‘Item 2’ notifies the customer that the buy-online-pick-up-in-store (BOPUS) price is less expensive ($115) than the in-store price ($125) for Item 2. In light of this notification about ‘Item 2’, the customer may opt not to purchase Item 2 at the merchant location and may remove the item from itemized bill (e.g., by swiping across the touchscreen to delete the item). While some examples of information that may be included in the offers/incentives section 802d have been provided, those skilled in the art in possession of the present disclosure will recognize a variety of other types of information that may be provided within the offers/incentives section 802d while remaining within the scope of the present disclosure. For example, in some embodiments, an offer or incentive may include an indication that shipment of a purchased item to another location (e.g., another state) will allow the customer to avoid payment of state taxes on the purchased item.

Continuing with the description of the customer device 600 as shown in FIG. 8, the pay button 802b may include a touchscreen interface button. In some embodiments, the customer may check-out of the Merchant A location by sliding the check-out slider 802c from right to left across the touchscreen user interface of the customer device 600. In some examples, the check-in slider 602c and the check-out slider 802c are substantially the same slider configured in one of two positions (e.g., a “checked-in position” or a “checked-out position”). In some embodiments, when a customer location is no longer in proximity to the merchant location (e.g., the Merchant A location), then the customer may be automatically checked-out of the merchant location. Illustratively, the customer may use the pay button 802c to confirm payment (e.g., via the payment service provider) to the Merchant A.

Thus, following block 504, the system provider device may have retrieved any product information that may affect the price the customer will pay for any of the products selected by the customer. For example, merchant provided product discounts, manufacturer rebates, associated product offers, and/or other information that may be relevant to the amount that the user will pay for the selected products may be retrieved at block 504.

The method 500 then proceeds to block 506 where information related to at least one customer payment account is retrieved (e.g., by the service provider). As described herein, a “payment account” may include cash on hand, savings and/or checking accounts (and associated debit cards), lines of credit (and associated credit cards), and may further include a payment service provider account (e.g., a PayPal account), or other account, which is linked to one or more of such payment accounts. In some examples, a particular merchant (e.g., a department store) may issue its own merchant-branded rewards card that may be linked to one or more customer payment accounts. In various embodiments, a customer shopping at a merchant with such a merchant-branded rewards card may be entitled to offers and/or promotions not available to other customers. As described above, a merchant may pay transaction (i.e., interchange) fees to a card-issuing bank (e.g., credit or debit card issuing bank) as well as to a credit card company for processing a credit and/or a debit card transaction. In some examples, transaction fees may also be paid to payment service providers. In addition to the fees paid by merchants and/or customers, card-issuing banks, credit card companies, and merchants may provide rewards such as points, discounts, cash, gift cards, merchandise, travel rewards and/or other incentives to a customer for using a particular type of payment. Thus, in some embodiments, retrieval of the at least one customer payment account may also include details associated with the customer payment account such as account number, account balance, available rewards and/or offers, interchange fee amounts, and/or other fees, rewards, or account information as known in the art.

Thus, following block 506, the system provider device may have retrieved any payment account information that may affect the price the customer will pay for any of the products selected by the customer. For example, payment account use incentives, payment account rewards incentives, and/or other information that may be relevant to the payment account that the user will use to pay for the selected products may be retrieved at block 506.

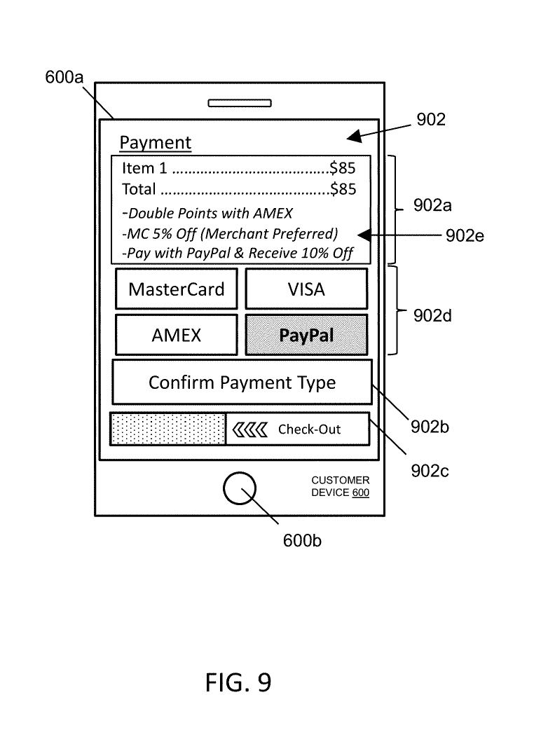

The method 500 then proceeds to block 508 where incentives and/or offers are provided to the customer, and where the offers are associated with purchasing, using the at least one payment account, the product with the received product identifier. Continuing with the example of FIG. 8, and with reference to FIG. 9, as the customer (e.g., the customer 702), decided not to purchase Item 2 at the Merchant A location and instead purchase it online, a payment confirmation screen 902, as shown in FIG. 9, only lists Item 1 in an itemized bill section 902a. As shown, the payment confirmation screen 902 provides the customer associated with the customer device 600 with a final itemized bill of the goods and/or services purchased from the Merchant A. In addition, the payment confirmation screen 902 may include a payment confirmation button 902b, a check-out slider 902c, and a payment account selection section 902d. By way of example, the payment account selection section 902d may include one or more available customer payment accounts (e.g., retrieved by the service provider). In the present example, four customer payment accounts (MasterCard®, VISA®, American Express®, and PayPal®) have been retrieved by the service provider and are thus displayed within the payment account selection section 902d. Furthermore, as described above, retrieval of the one or more customer payment accounts may also include retrieval of payment account numbers, balances, rewards and/or offers, fees, or other account information. In various embodiments, such fees, offers, or other information for each of the available customer payment accounts may be displayed in a payment account information section 902e of the payment confirmation screen 902.

Merely by way of example, the payment account information section 902e of FIG. 9 shows several offers associated with the customer payment accounts that have been retrieved, including double reward points for using American Express® (AMEX), a 5% discount for using MasterCard® (MC) (which in this example is also a merchant-preferred payment type), and a 10% discount for using PayPal. In some embodiments, a merchant-preferred payment type may automatically include a payment type having the lowest transaction fees. In other embodiments, a merchant-preferred payment type may be manually selected by a merchant, for example, in conjunction with a bank promotion, a manufacturer promotion, a payment service provider promotion, or other type of promotion. In addition, as shown in FIG. 6, a customer may configure a default or preferred payment method (e.g., AMEX). However, in some embodiments, the customer may decide on-the-fly (i.e., at the time-of-purchase) which payment method to use based on the presented fees, offers, promotions, etc., and may further override any pre-existing default or preferred payment methods. In the example of FIG. 9, the customer has elected to pay with PayPal, as indicated by the textured pattern of the PayPal button in the payment account selection section 902d. While the customer in this particular example may generally prefer to pay with AMEX, the $5 PayPal manufacturer incentive (FIG. 8), as well as the 10% payment service provider (PayPal) purchase discount, convinced the customer that paying with PayPal was the optimum choice for the given set of circumstances. It will be readily understood that as circumstances change, including for example when the customer is shopping at a different merchant, when the customer is shopping at the same merchant at a different time or season, or when different incentives and/or offers are available, the choice of which available customer payment account to use may also change.

The method 500 then proceeds to block 510 where a purchase instruction is received, by the service provider, from the customer. For example, with reference again to FIG. 9, after the customer selects which customer payment account to use, the customer may then press the payment confirmation button 902b to complete the payment transaction, and thus send a purchase instruction to the service provider. However, in some embodiments, a merchant (e.g., Merchant A) may make a counter-offer, for example, in response to the customer's selected payment account choice. For example, in various embodiments, the merchant may be aware of the fees, offers, incentives, and other information associated with each customer payment account for the purchase of the selected one or more items 706 (e.g. including Items 1 and 2) by way of such information being displayed on a merchant device. Thus, for example when the customer selects to pay with PayPal (FIG. 9), the merchant may offer a counter-offer, or counter-bid, to match the incentive (i.e., match the PayPal discounts) if the customer pays with a merchant-preferred payment type (e.g., Mastercard®, in this example). Various other types and methods of merchant counter-bidding will become apparent to one skilled in the art in possession of the present disclosure while remaining within the scope of the present disclosure.

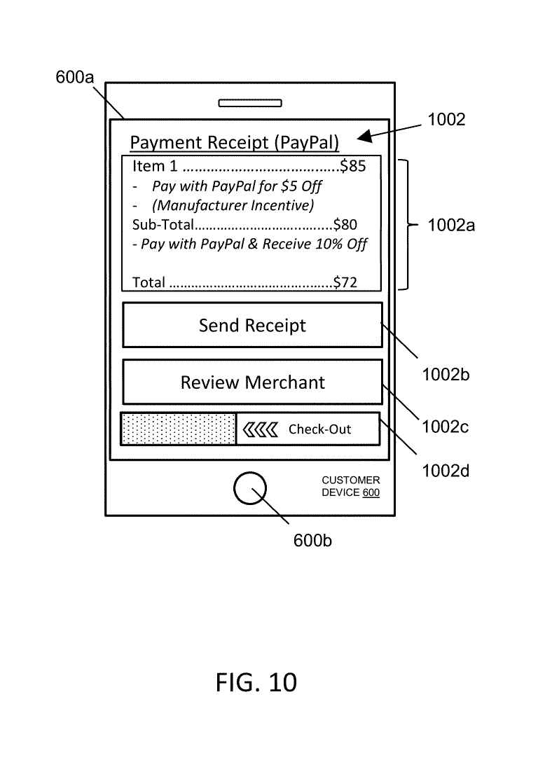

Referring to FIG. 10, therein is illustrated a payment receipt screen 1002, which lists purchased Item 1 in an itemized receipt section 1002a. The itemized receipt section 1002a may also include the applied offers, promotions, discounts, fees, offers, or other information relative to the purchase of Item 1. For example, FIG. 10 illustrates that the original retail price of Item 1 ($85) was reduced by $5 in light of a manufacturer incentive, resulting in a sub-total of $80, which was then further discounted by 10% due to the payment service provider (PayPal) purchase discount, resulting in a final purchase price of $72. For purposes of clarity in the discussion, taxes have not been considered in the examples described herein. As shown, the payment receipt screen 1002 may further include a send receipt button 1002b, a review merchant button 1002c, and a check-out slider 1002d. In some embodiments, the customer may send themselves, or someone else, a copy of their payment receipt by way of the send receipt button 1002b. For example, the customer may send the payment receipt to an e-mail address, a mobile device, or other device. In some embodiments, the customer may also leave a review and/or feedback for the merchant (e.g., Merchant A) using the review merchant button 1002c, where such a review may be aggregated with other reviews and the merchant rating 602b (FIG. 6) may thus be updated.

In a specific embodiment of the method 500 discussed above, a customer may select a “big-ticket”, or relatively expensive, item for purchase from a merchant. For example, the customer may select a $3500.00 television for purchase. Upon presenting the television for purchase to the merchant, the merchant may scan the television product identifier such that the television is identified to the system provider device. The customer may be identified to the system provider device and associated with the television based the proximity of their customer device to, for example, the merchant device that was used to scan the television product identifier.

The system provider device may then operate to retrieve any offers and incentives that are associated with the television such as, for example, manufacturer rebates for the television, merchant discounts for the television, associated product deals available when purchasing the television, etc. The system provider device may also operate to retrieve information associated with one or more payment accounts of the customer such as interchange fees, cash-back or other rewards associated with using a payment account, etc. In addition, the system provider device may retrieve any other information that may affect the price, or benefits associated with the purchase of, the television, such as the sales tax associated with shipping the television to different locations, incentives offered by the merchant to reduce transaction costs paid by the merchant, etc.

Then, prior to the customer paying for the television, the system provider device may provide all the information that was retrieved to the customer (e.g., via the customer device) so that the customer can determine the best manner in which to pay for the television. This results in the customer being provided a variety of information about different manners in which the television may be paid for, and allows the customer to select how the television is purchased, whom it is purchased from, the payment method used to purchase the television, etc., in a manner that optimizes the benefits to the customer. In addition, in response to the selection by the customer of incentives and/or payment methods for the television, the merchant may counter-offer a reduced price for the television to attempt to incentivize the customer to purchase using a different incentive and/or different payment method such that the television is purchased by the customer in a manner that is optimized for the merchant as well. For example, the savings to a merchant associated with using a debit card over a credit card may be shared with a customer, thus reducing the cost of the transaction to both the customer and merchant.

Thus, systems and methods have been described that provide for the surfacing of transaction fee information, as well as relevant incentives and offers, to a customer that has one or more payment methods at their disposal. For example, and in accordance with the various embodiments described herein, customers may be readily able to view transaction fee information, incentives and/or other offers (e.g., provided by a merchant, bank, payment service provider, manufacturer, or other third-party), all at a time-of-purchase. This provides a customer with previously unavailable information, and allows the customer to quickly compare fees, incentives, or offers related to the purchase of one or more particular items, at a particular merchant, using one or more particular methods of payment at a customer's disposal. Thus, the embodiments described herein provide a customer with the ability to select an optimum method of payment (e.g., as determined by the customer) for any of a variety of merchant/customer interactions and situations.

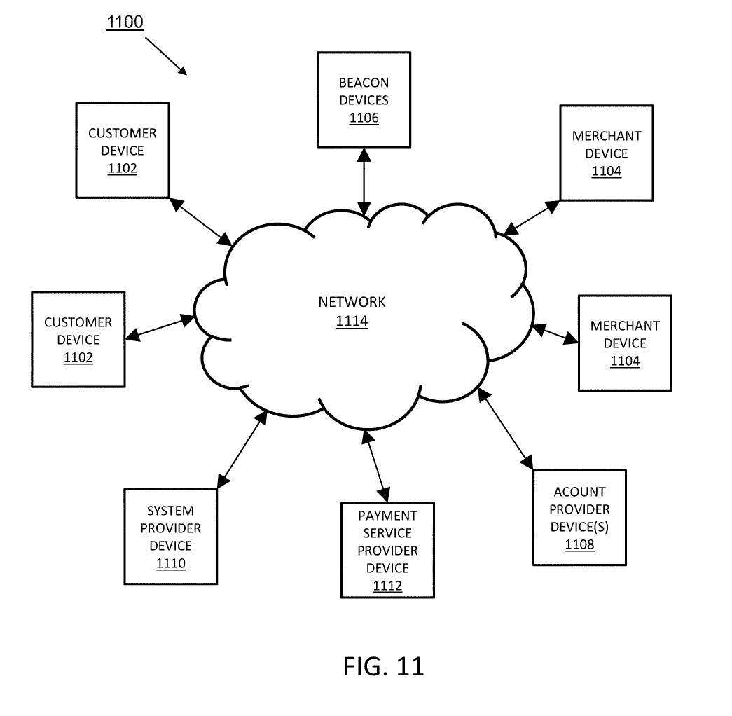

Referring now to FIG. 11, an embodiment of a network-based system 1100 for implementing one or more processes described herein is illustrated. As shown, the network-based system 1100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 11 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 1100 illustrated in FIG. 11 includes a plurality of customer devices 1102, a plurality of merchant devices 1104, a plurality of beacon devices 1106, a payment service provider device 1112, account provider device(s) 1108, and/or a system provider device 1110 in communication over one or more networks 1114. The customer devices 1102 may be the customer devices discussed above and may be operated by the customers discussed above. The merchant devices 1104 and beacon devices 1106 may be the merchant devices and beacon devices discussed above and may be operated by the merchants discussed above. The payment service provider device 1112 may be the payment service provider devices discussed above and may be operated by a payment service provider such as, for example, PayPal Inc. of San Jose, Calif. The system provider devices 1110 may be the system provider devices discussed above and may be operated by the system providers discussed above. The account provider devices 1108 may be operated by credit card account providers, bank account providers, savings account providers, and a variety of other account providers known in the art.

The customer devices 1102, merchant devices 1104, beacon devices 1106, payment service provider device 1112, account provider devices 1108, and/or system provider device 1110 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 1100, and/or accessible over the network 1114.

The network 1114 may be implemented as a single network or a combination of multiple networks. For example, in various embodiments, the network 1114 may include the Internet and/or one or more intranets, landline networks, wireless networks, and/or other appropriate types of networks.

The customer devices 1102 may be implemented using any appropriate combination of hardware and/or software configured for wired and/or wireless communication over network 1114. For example, in one embodiment, the customer devices 1102 may be implemented as a personal computer of a user in communication with the Internet. In other embodiments, the customer devices 1102 may be a smart phone, wearable computing device, laptop computer, and/or other types of computing devices.

The customer devices 1102 may include one or more browser applications which may be used, for example, to provide a convenient interface to permit the customer to browse information available over the network 1114. For example, in one embodiment, the browser application may be implemented as a web browser configured to view information available over the Internet.

The customer devices 1102 may also include one or more toolbar applications which may be used, for example, to provide user-side processing for performing desired tasks in response to operations selected by the customer. In one embodiment, the toolbar application may display a user interface in connection with the browser application.

The customer devices 1102 may further include other applications as may be desired in particular embodiments to provide desired features to the customer devices 1102. In particular, the other applications may include a payment application for payments assisted by a payment service provider through the payment service provider device 1112. The other applications may also include security applications for implementing user-side security features, programmatic user applications for interfacing with appropriate application programming interfaces (APIs) over the network 1114, or other types of applications. Email and/or text applications may also be included, which allow customer payer to send and receive emails and/or text messages through the network 1114. The customer devices 1102 includes one or more user and/or device identifiers which may be implemented, for example, as operating system registry entries, cookies associated with the browser application, identifiers associated with hardware of the customer devices 1102, or other appropriate identifiers, such as a phone number. In one embodiment, the user identifier may be used by the payment service provider device 1112 and/or account provider device 1108 to associate the user with a particular account as further described herein.

The merchant devices 1104 may be maintained, for example, by a conventional or on-line merchant, conventional or digital goods seller, individual seller, and/or application developer offering various products and/or services in exchange for payment to be received conventionally or over the network 1114. In this regard, the merchant device 1104 may include a database identifying available products and/or services (e.g., collectively referred to as items) which may be made available for viewing and purchase by the customer.

The merchant devices 1104 also include a checkout application which may be configured to facilitate the purchase by the payer of items. The checkout application may be configured to accept payment information from the user through the customer devices 1102, the account provider through the account provider device 1108, and/or from the payment service provider through the payment service provider device 1112 over the network 1114.

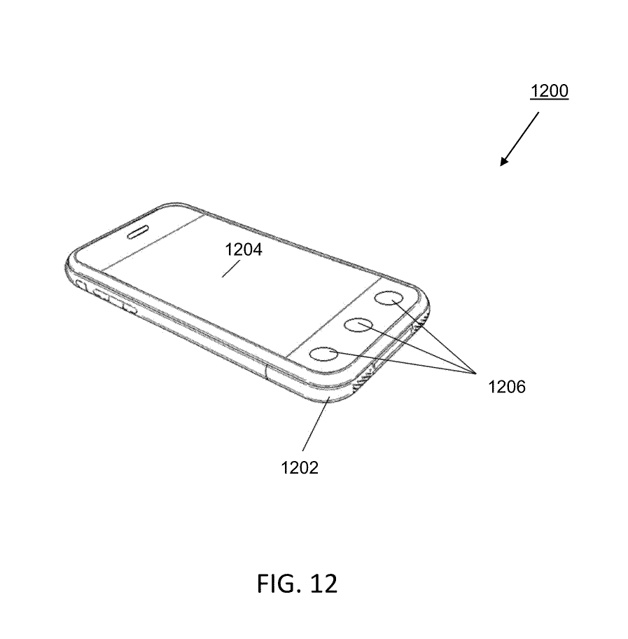

Referring now to FIG. 12, an embodiment of a customer device 1200 is illustrated. The customer device 1200 may be the customer device 600 or 1102 discussed above. The customer device 1200 includes a chassis 1202 having a display 1204 and an input device including the display 1204 and a plurality of input buttons 1206. One of skill in the art will recognize that the customer device 1200 is a portable or mobile phone including a touch screen input device and a plurality of input buttons that allow the functionality discussed above with reference to the methods above. However, a variety of other portable/mobile customer devices and/or desktop customer devices may be used in the methods discussed above without departing from the scope of the present disclosure.

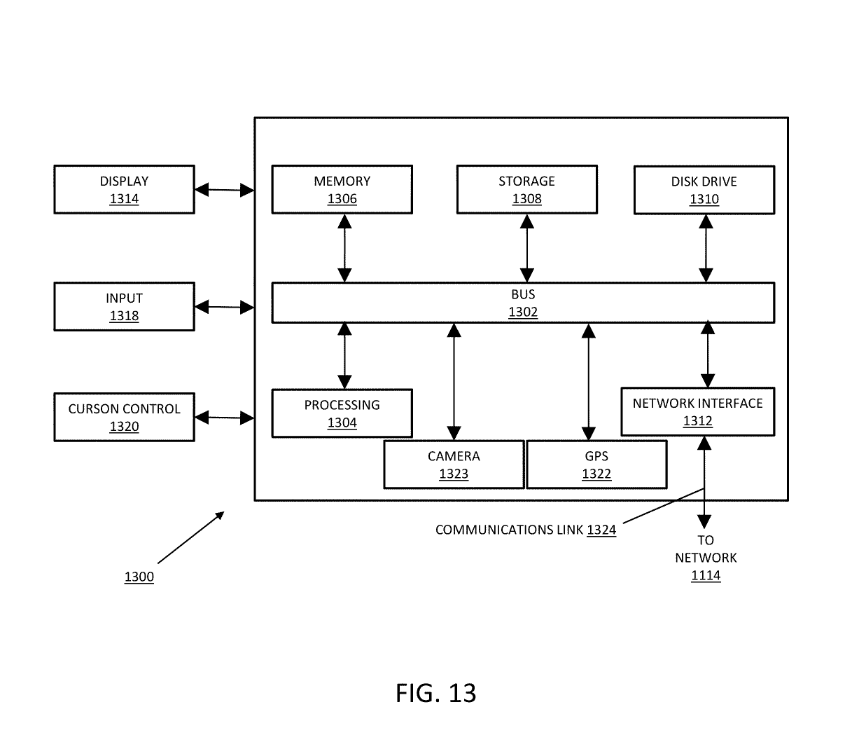

Referring now to FIG. 13, an embodiment of a computer system 1300 suitable for implementing, for example, the customer device 600 or 1102, merchant device 1104, beacon devices 200, 404, or 1106, payment service provider device 1112, account provider device(s) 1108, and/or system provider devices 402 or 1110, is illustrated. It should be appreciated that other devices utilized by customers, merchants, beacon devices, merchant beacon communication devices, payment service providers, account provider device(s), and/or system providers in the system discussed above may be implemented as the computer system 1300 in a manner as follows.

In accordance with various embodiments of the present disclosure, computer system 1300, such as a computer and/or a network server, includes a bus 1302 or other communication mechanism for communicating information, which interconnects subsystems and components, such as a processing component 1304 (e.g., processor, micro-controller, digital signal processor (DSP), etc.), a system memory component 1306 (e.g., RAM), a static storage component 1308 (e.g., ROM), a disk drive component 1310 (e.g., magnetic or optical), a network interface component 1312 (e.g., modem or Ethernet card), a display component 1314 (e.g., CRT or LCD), an input component 1318 (e.g., keyboard, keypad, or virtual keyboard), a cursor control component 1320 (e.g., mouse, pointer, or trackball), a location determination component 1322 (e.g., a Global Positioning System (GPS) device as illustrated, a cell tower triangulation device, and/or a variety of other location determination devices known in the art), and/or a camera component 1323. In one implementation, the disk drive component 1310 may comprise a database having one or more disk drive components.

In accordance with embodiments of the present disclosure, the computer system 1300 performs specific operations by the processor 1304 executing one or more sequences of instructions contained in the memory component 1306, such as described herein with respect to the customer devices 600 or 1102, merchant device 1104, beacon devices 200, 404, or 1106, payment service provider device 1112, account provider device(s) 1108, and/or system provider devices 402 or 1110. Such instructions may be read into the system memory component 1306 from another computer readable medium, such as the static storage component 1308 or the disk drive component 1310. In other embodiments, hard-wired circuitry may be used in place of or in combination with software instructions to implement the present disclosure.

Logic may be encoded in a computer readable medium, which may refer to any medium that participates in providing instructions to the processor 1304 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 1310, volatile media includes dynamic memory, such as the system memory component 1306, and transmission media includes coaxial cables, copper wire, and fiber optics, including wires that comprise the bus 1302. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 1300. In various other embodiments of the present disclosure, a plurality of the computer systems 1300 coupled by a communication link 1324 to the network 1114 (e.g., such as a LAN, WLAN, PTSN, and/or various other wired or wireless networks, including telecommunications, mobile, and cellular phone networks) may perform instruction sequences to practice the present disclosure in coordination with one another.

The computer system 1300 may transmit and receive messages, data, information and instructions, including one or more programs (i.e., application code) through the communication link 1324 and the network interface component 1312. The network interface component 1312 may include an antenna, either separate or integrated, to enable transmission and reception via the communication link 1324. Received program code may be executed by processor 1304 as received and/or stored in disk drive component 1310 or some other non-volatile storage component for execution.

Referring now to FIG. 14, an embodiment of a system provider device 1400 is illustrated. In an embodiment, the device 1400 may be the system provider devices discussed above. The device 1400 includes a communication engine 1402 that is coupled to the network 1114 and to a transaction fee engine 1404 that is coupled to a customer information database 1406 and a merchant information database 1408. The communication engine 1402 may be software or instructions stored on a computer-readable medium that allows the device 1400 to send and receive information over the network 1114. The transaction fee engine 1404 may be software or instructions stored on a computer-readable medium that, when executed by a processor, is configured to receive a product identifier and associate the product identifier with a customer, retrieve incentives and/or offers associated with a product having the received product identifier, retrieve information related to at least one customer payment account, provide incentives and/or offers to the customer associated with purchasing, using the at least one payment account, the product having the received product identifier, and receiving a purchase instruction from the customer, as well as provide any of the other functionality that is discussed above. While the databases 1406 and 1408 have been illustrated as located in the device 1400, one of skill in the art will recognize that they may be connected to the transaction fee engine 1404 through the network 1114 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants and customers; however, a customer or consumer can pay, or otherwise interact with any type of recipient, including charities and individuals. The payment does not have to involve a purchase, but may be a loan, a charitable contribution, a gift, etc. Thus, merchant as used herein can also include charities, individuals, and any other entity or person receiving a payment from a customer. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system, comprising:
at least one non-transitory memory storing merchant information; and
one or more hardware processors that are coupled to the at least one non-transitory memory and that are configured to read instructions from the at least one non-transitory memory to perform the steps of:
retrieving a product identifier for a product over a network from a merchant device and determining a customer device associated with the product;
retrieving incentives associated with the product from a database in the at least one non-transitory memory;
determining at least one customer payment account associated with the customer device and retrieving information associated with the at least one customer payment account from the database in the at least one non-transitory memory;
providing incentives for a particular purchase instruction associated with purchasing the product using the at least one customer payment account, wherein the incentives for the particular purchase instruction are provided for display on the customer device; and
receiving a purchase instruction selection.

2. The system of claim 1, wherein the one or more hardware processors are further operable to read instructions from the at least one non-transitory memory to perform the steps of:
retrieving information associated with a plurality of customer payment accounts from the database in the at least one non-transitory memory;
providing incentives for respective purchase instructions associated with purchasing the product using each of the plurality of customer payment accounts, wherein the incentives for the respective purchase instructions are provided for display on the customer device; and
receiving the purchase instruction selection.

3. The system of claim 1, wherein the one or more hardware processors are further operable to read instructions from the at least one non-transitory memory to perform the steps of:
receiving identifying information associated with the customer device; and
determining the product is associated with the customer device using the identifying information associated with the customer device.

4. The system of claim 3, wherein the identifying information associated with the customer device includes data collected from at least one beacon device.

5. The system of claim 1, wherein the incentives include one or more of a merchant incentive, a bank incentive, a payment service provider incentive, and a manufacturer incentive.

6. The system of claim 1, wherein the at least one customer payment account include one of a savings account, a checking account, a credit account, and a payment service provider account.

7. The system of claim 1, wherein the one or more hardware processors are further operable to read instructions from the at least one non-transitory memory to perform the steps of:
providing the incentives for the particular purchase instruction associated with purchasing the product using the at least one customer payment account, wherein the incentives for the particular purchase instruction are provided for display on the merchant device; and
responsive to receiving the purchase instruction selection, receiving a merchant incentive counter-offer.

8. The system of claim 2, wherein the one or more hardware processors are further operable to read instructions from the at least one non-transitory memory to perform the steps of:
providing the incentives for the respective purchase instructions associated with purchasing the product using each of the plurality of customer payment accounts, wherein the incentives for the respective purchase instructions are provided for display on the merchant device; and
responsive to receiving the purchase instruction selection, receiving a merchant incentive counter-offer.

9. The system of claim 7, wherein the merchant incentive counter-offer includes a matching incentive for the particular purchase instruction associated with purchasing the product using the at least one customer payment account.

10. The system of claim 8, wherein the merchant incentive counter-offer includes a matching incentive for each of the respective purchase instructions associated with purchasing the product using each of the plurality of customer payment accounts.

11. A method, comprising:
retrieving, by a system provider device through a network, a product identifier for a product over a network from a merchant device and determining a customer device associated with the product;
retrieving, by the system provider device, incentives associated with the product from a database;
determining, by the system provider device, at least one customer payment account associated with the customer device and retrieving information associated with the at least one customer payment account from the database;
providing, by the system provider device, incentives for a particular purchase instruction associated with purchasing the product using the at least one customer payment account, wherein the incentives for the particular purchase instruction are displayed on the customer device; and
receiving, by the system provider device, a purchase instruction selection.

12. The method of claim 11, further comprising:
retrieving, by the system provider device, information associated with a plurality of customer payment accounts from the database in the at least one non-transitory memory;
providing, by the system provider device, incentives for respective purchase instructions associated with purchasing the product using each of the plurality of customer payment accounts, wherein the incentives for the respective purchase instructions are displayed on the customer device; and
receiving, by the system provider device, the purchase instruction selection.

13. The method of claim 11, further comprising:
receiving, by the system provider device, identifying information associated with the customer device; and
determining, by the system provider device, the product is associated with the customer device using the identifying information associated with the customer device.

14. The method of claim 13, wherein the identifying information associated with the customer device includes data collected from at least one beacon device.

15. The method of claim 11, further comprising:
providing, by the system provider device, the incentives for the particular purchase instruction associated with purchasing the product using the at least one customer payment account, wherein the incentives for the particular purchase instruction are displayed on the merchant device; and
responsive to receiving the purchase instruction selection, receiving, by the system provider device, a merchant incentive counter-offer.

16. The method of claim 12, further comprising:
providing, by the system provider device, the incentives for the respective purchase instructions associated with purchasing the product using each of the plurality of customer payment accounts, wherein the incentives for the respective purchase instructions are displayed on the merchant device; and
responsive to receiving the purchase instruction selection, receiving, by the system provider device, a merchant incentive counter-offer.

17. A non-transitory machine-readable medium comprising a plurality of machine-readable instructions executable by one or more processors to cause the one or more processors to perform a method comprising:
retrieving a product identifier for a product over a network from a merchant device and determining a customer device associated with the product;
retrieving incentives associated with the product from a database;
determining at least one customer payment account associated with the customer device and retrieving information associated with the at least one customer payment account from the database;
providing for display, on the customer device, incentives for a particular purchase instruction associated with purchasing the product using the at least one customer payment account; and
processing a purchase instruction selection.

18. The non-transitory machine-readable medium of claim 17, wherein the method further comprises:
retrieving information associated with a plurality of customer payment accounts from the database;
providing for display, on the customer device, incentives for respective purchase instructions associated with purchasing the product using each of the plurality of customer payment accounts; and
processing the purchase instruction selection.

19. The non-transitory machine-readable medium of claim 17, wherein the method further comprises:
processing identifying information associated with the customer device; and
generating an association between the product and the customer device using the identifying information.

20. The non-transitory machine-readable medium of claim 17, wherein the method further comprises:
displaying, on the merchant device, the incentives for the particular purchase instruction associated with purchasing the product using the at least one customer payment account; and
responsive to processing the purchase instruction selection, processing a merchant incentive counter-offer.
